(19) United States
(12) Patent Application Publication
(10) Pub. No.: US 2013/0080469 A1
(43) Pub. Date: Mar. 28, 2013

(54) SYSTEM AND METHOD FOR SELECTING EXTENDED SEARCH WORD

(71) Applicant: Jin-Keun Choi, Seoul (KR)

(72) Inventor: Jin-Keun Choi, Seoul (KR)

(73) Assignee: Jin-Keun CHOI, Seoul (KR)

(21) Appl. No.: 13/700,679

(22) PCT Filed: May 27, 2011
(86) PCT No.: PCT/KR2011/003896

§ 371 Date: Nov. 28, 2012

(30) Foreign Application Priority Data
May 28, 2010 (KR) 10-2010-0050381

(51) Int. Cl. G06F 17/30; G06F 3/0485

(52) U.S. Cl. CPC G06F 17/30979; G06F 3/0485
USPC 707/772

(57) ABSTRACT

The present invention relates to an extended search word selection system and method, which provides related words associated with a search word of a user to select an extended search word. The extended search word selection system of the present invention comprises a user terminal and a search server, the search server being configured to receive a search word from the user terminal, search related words corresponding to the search word and provide the searched related words; and the user terminal being configured to display at least one word-list window horizontally disposed on the screen; transmit a search word selected from the related words displayed in a first word-list window for search request; receive at least one related word from the search server to display the related words in a second word-list window adjacent to the first word-list window; and scroll the word-list windows to the left or right to display the word-list windows that are not displayed on the screen, thereby exhibiting the history of the selection of the search words and the related words of each search word on the screen. In accordance with the present invention, the first related words of an input search word of a user and then second related words of a search word selected by the user from the first related words are provided.

### TECHNICAL FIELD

The present invention relates to an extended search word selection system, which comprises the provision of first related words of a search word input by a user and then second related words of a search word selected by the user from the first related words.

### BACKGROUND ART

The present application claims priority to Korean Patent Application No. 10-2010-0050381 filed in the Republic of Korea on May 28, 2010, the disclosure of which is incorporated herein by reference.

A conventional internet web search is performed on the basis of a search word input in a search window by a user. The search word requested by the user is searched through a search server and then the results thereof are provided. The user reviews the search results, and if a detailed search is desired, the user selects a specific keyword among the search results and again inputs the selected keyword for a further search.

Such a search method repeats the procedure of a user inputting a search word in a search window, reviewing the search results, inputting the other search word again in the search window for a further search or a new search.

When repeating the search procedure that requires the input of at least one word in a search window, the user inputs numerous search words, from which the same search word may be repeatedly input at every instance a search is requested.

For example, in the case of 6 total instances of requesting a search in a search window, such as ‘A, A+B, A-1+B, B, A-1, A+A-1’, a user first inputs “A” as a search word and receives its search results, and reviews the search results of the 6 total instances and then selects the search words 6 times. That is, in order to select the most suitable search word in the conventional search method, a user reviews the contents of the previous search result and then selects a search word such as B and A-1 therefrom, repeating the search. From the 6 total search instances, the keyword “A” is repeatedly input 4 times, “B”, 3 times, and “A-1”, 3 times, respectively. Such a repeated search method results in a user inconveniently having to repeatedly review the search results and subsequently the selection of a suitable search word. Also, as the number of a search increases, the search word previously input may be repeatedly input and its input possibility may increase.

Thus, the cycle of the conventional search method is summarized in the repeated procedures of i) the input of a search word, ii) a search request, iii) the review of search results, iv) the selection of other search word, and v) the repetition of procedures of steps i) to iv).

### DISCLOSURE

### Technical Problem

The present invention is designed with respect to the prior art, and therefore it is an object of the present invention to provide a system and method for providing the display of search results including extended search words and related words searched by each search word in every search step and for maintaining the search history of the search results in every search step.

Also, the present invention is to provide a selection of an extended search word in every search step displaying the above-mentioned search results and receiving the search request of a search word selected from the related words.

### Technical Solution

In order to accomplish the above object, in accordance with one aspect of the present invention, there is provided an extended search word selection system, which whenever selecting a specific word in an individual word-list window displayed on a screen using a wire/wireless network, provides related words associated with the selected specific word in an adjacent word-list window, the system comprising a user terminal and a search server, the search server being configured to receive a search word from the user terminal, search related words corresponding to the search word and provide the searched related words; and the user terminal being configured to display at least one word-list window horizontally disposed on the screen; transmit a search word selected from the related words displayed in a first word-list window for search request; receive at least one related word from the search server to display the related words in a second word-list window adjacent to the first word-list window; and scroll the word-list windows left or right to display the word-list windows that are not displayed on the screen, thereby exhibiting the history of the selection of the search words and the related words of each search word on the screen.

Further, when the user selects a specific search word in a mth word-list window where m is 1 or higher (m≧1), the user terminal displays the related words of the search word in a ‘m+1’th word-list window, and in the case that the m+1’th word-list window is not displayed on the screen due to insufficient space, the user terminal scrolls the word-list window to the left on the screen to display the ‘m+1’th word-list.

In the present invention, the user terminal displays at least one search word selected by the user among the search word input by the user and the related words of total word-list windows, and transmits at least one word selected to the search server for search request.

Also, the user terminal displays a search result-list window below the word-list windows on the screen; transmits a search word input by the user to the search server for search request; receives similar words considered to be predictive words by adding a letter to the search word, the related words and the search results of the search word, and displays the search word and the similar words in the first word-list window while displaying the search results in the search result-list window, and when the user selects a specific search word in a mth word-list window where m is 1 or higher (m≧1), the user terminal transmits a search word of a ‘m−1’th word-list window (‘m−1’th search word) and a search word of a mth word-list window (mth) to the search server for search request, receives related words of the mth search word and search results for the combination of the ‘m−1’th search word and the mth search word from the search server, and displays the received related words in a ‘m+1’th word-list window, while displaying the received search results in the search result-list window.

In accordance with another aspect of the present invention, there is provided an extended search word selection system, which whenever selecting a specific word node in a graph using a wire/wireless network, provides the node information of related words of the specific word node in a graph displayed on a screen by connecting the nodes of the words with each other, the system comprising a user terminal and a search server, the search server being configured to receive a word in the graph as a search word from the user terminal, search the word to find related words corresponding to the word, and provide the node information of the related words; and the user terminal being configured to display a graph window on the screen, which transmits the word selected by the user as a search word to the search server when the specific word node is selected in the graph window, receives the node information of the related words from the search server, and displays the node information of the related words received by connecting the node information of the related words with the selected word node in the graph window in a graph form.

Also, the search server has a database that stores core words and related words associated with the core words, and receive each search word selected by the user in every step and searches the search word as the core word to provide related words associated with the search word.

In the present invention, the related words are arrayed and displayed depending on the selection frequency of each word by the user and the number of contents corresponding to each related word.

In addition, the user terminal displays a graph window in which a plurality of words and related words of each word are connected in a node form and displayed in a graph form, on the screen; when a specific search word is selected in the individual word-list window, displays word nodes corresponding to the search word in the graph window, and when related words of the search word are displayed in the individual word-list window, further displays the node information of the related words of the search word in a graph form in the graph window by connecting the node information.

Further, in the state that a nth graph is displayed in the graph window, the user terminal initializes the graph window to display a ‘n+1’th graph when the ‘n+1’th graph of the related words cannot be further displayed due to insufficient space of the graph-displaying area.

In accordance with still another aspect of the present invention, there is provided an extended search word selection method, which whenever a user selects a specific word in an individual word-list window displayed on a screen using a wire/wireless network, provides related words in an adjacent word-list window, the method comprising: (a) inputting a search word in a search window displayed on the screen of a user terminal in which at least one word-list window is horizontally arrayed and displayed on the screen thereof, and transmitting the search word to a search server; (b) searching the search word received in the search server to provide related words associated with the search word to the user terminal; (c) displaying the related words received in a first word-list window of the user terminal; (d) transmitting a specific related word selected as a search word to the search server when the specific related word is selected in the first word-list window; (e) searching the search word received in the search server to provide its related words to the user terminal; (f) displaying the related words received in a second word-list window adjacent to the first word-list window in the user terminal, and (g) displaying the word-list windows not displayed on the screen by means of scrolling left or right in the user terminal to exhibit the history of the search words selected since the initial search and the related words of each search word on the screen.

### Advantageous Effects

In accordance with the present invention, related words associated with a search word selected by a user in a word-list window can be provided in an adjacent word-list window, and total related words extended in each word-selecting step are exhibited in the word-list windows, thereby allowing the user to check extended search words by scrolling the word-list window left or right.

Also, a user can search navigate by returning from a certain word-list window to a precedent word-list window to select again the other search word instead of the search word previously selected.

In addition, a user can perform a search with search words of two adjacent word-list windows during search navigation, thereby allowing the user to approach the information of another field which is different from the information of the pre-searched field.

### DESCRIPTION OF DRAWINGS

The accompanying drawings illustrate preferred embodiments of the present invention and, together with the foregoing disclosure, serve to provide further understanding of the technical spirit of the present disclosure. However, the present disclosure is not to be construed as being limited to the drawings.

FIG. 1 schematically shows a configuration of an extended search word selection system according to one embodiment of the present invention.

FIG. 2 illustrates an extended search word selection according to one embodiment of the present invention.

FIGS. 3 to 5 show captured search views according to one embodiment of the present invention.

FIG. 6 illustrates an extended search word selection by using a graph according to one embodiment of the present invention.

FIG. 7 illustrates the display of a graph after initialization in the case that there is insufficient graph-displaying area in FIG. 6

FIG. 8 schematically shows a configuration of a search server according to one embodiment of the present invention.

FIG. 9 shows a schematic flow chart of an extended search word selection method according to one embodiment of the present invention.

FIG. 10 shows a schematic flow chart of an extended search word selection method by using a graph according to one embodiment of the present invention.

### BEST MODE

Hereinafter, preferred embodiments of the present invention will be described in detail with reference to the accompanying drawings.

<1. Extended Search Word Selection System>

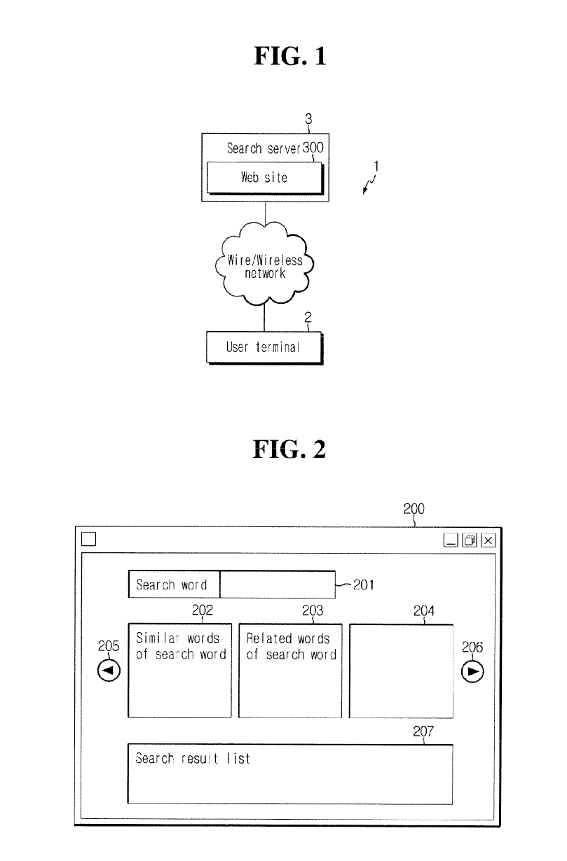

FIG. 1 schematically shows a configuration of an extended search word selection system 1 according to one embodiment of the present invention.

The extended search word selection system 1 according to one embodiment of the present invention comprises a user terminal 2 and a search server 3, in which the user terminal 2 transmits a search word input by a user in a wire/wireless network to a search server 3 for search request, receives and displays related words and search results step by step and the search server 3 provides the related words and search results in every step in which a search is requested from the user terminal 2.

In the present invention, the wire/wireless network may include all networks capable of an internet data communication using various protocols, for example, a mobile communication network and wire/wireless public or personal communication network such as internet.

The user terminal 2 may include any terminal capable of accessing an internet website, for example, a computer terminal, a mobile communication terminal, a smart terminal such as a smart phone and a smart pad, and etc.

The search server 3 provides the extended search word selection service to the user terminal 2 which accesses a website 300. The term ‘extended search word selection service’ which is used herein refers to providing a list of related words associated with a search word input by a user, and providing a list of related words corresponding to a keyword selected by the user among the list of related words. Accordingly, the user selects a specific keyword as a search word in each step in which a list of related words is provided, thereby allowing an extended search.

For this, the search server 3 may store a database of associative words which defines an association between words (core words and related words). The term “association” which is used herein refers to an association of the related words based on the core words. The database of associative words may include at least one related word per core word. Exemplary data are shown in Table 1 in the case that the database of associative words includes one related word for each core word.

TABLE 1

| Core Word | Related Word |
|---|---|
| A | A-1 |
| A | B |
| B | B-1 |
| B | BB |
| . . . | . . . |

In Table 1, in the case that a user inputs “A” as a search word and requests its search, the search server 3 reads related words “A-1” and “B” from the database and provides them to the user terminal 2, then the user terminal 2 fills the received related words “A-1” and “B” in an individual word-list window. In the case that that the user selects “B” in a word-list window, the search server 3 reads and provides related words “B-1” and “BB” from the database for the core word “B”, then the related words of “B” are filled in the individual word-list window. Meanwhile, in the database of Table 1, a search result field may be further added, and a link of n (n≧0) number of search result contents, in which core words and related words are searched, is stored in the search result field.

Also, separate from the database of associative words, a database of contents may be stored, the database of contents including a plurality of keywords (tags) per each content (a document, a picture, a video, and the like) which is provided as a search result to the user. The search server 3 may search contents from the contents database by itself and provide search results to the user terminal 2, or may request the contents searched through an open API to other search engines and provide search results received therefrom to the user terminal.

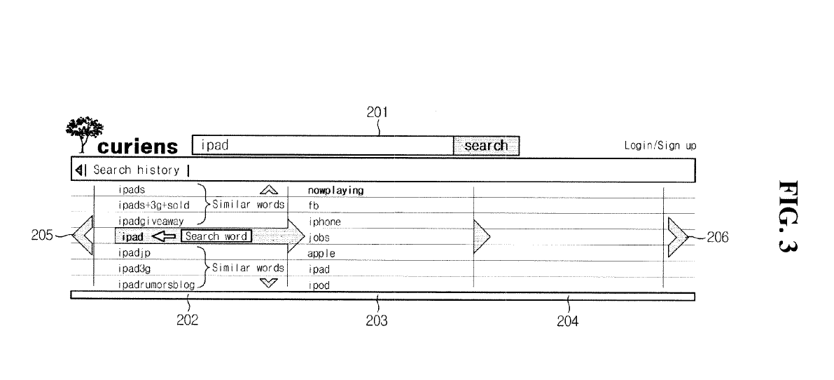

FIG. 2 illustrates an interface of an extended search word selection according to one embodiment of the present invention.

First, a user inputs a search word in the search window 201 of a search page provided by accessing a website 300 to request a search. The search server 3 receives the search word from the user terminal 2 and searches the search word to provide similar words and related words having association. The term “similar words” which is used herein refers to words considered to be predictive words of a search word by adding a consonant or a vowel to an input search word. After the user terminal 2 receives the similar words and related words as the search result, a list of the similar words is filled in a first word-list window 202, and the search word input by the user is positioned in the middle thereof. Also, the related words are read from the associative words database by searching the search word as a core word and then filled in a second word-list window 203. That is, the second word-list window 203 is filled with the related words associated with the search word of the first word-list window 202, the search word being a core word. At this time, the similar words and the related words may be sorted depending on the selection frequency of each word by the user and the number of contents corresponding to each related word.

Next, when the user selects a specific keyword as a search word in the second word-list window 203, the search word is transmitted to the search server 3 in which the search word is searched for its related words from the associative words database, and a list of the related words is provided and filled in a third word-list window 204. This means that the search word is searched as a core word from the database to read the related words associated with the core word and the related words are filled in the word-list window. When the second word-list window 203 and the third word-list window 204 are each filled with the related words, after inputting the search word in the search window 201, the user meets the extended search of the search word twice.

Then, when the user selects a search word in the third word-list window 204, the search word is transmitted to the search server 3 so that its related words can be provided. In this case, in order to display a list of the related words provided from the search server 3, the word-list windows roll up to the left by one column. That is, each word-list window moves to the left by one column, the data of the second word-list window 203 are displayed in the first word-list window 202, and the data of the third word-list window 204 are displayed in the second word-list window 203, while the list of the newly provided related words are displayed in the third word-list window 204. From such a process, the extended search of the search word is achieved. Also, whenever the user touches a left or right arrow button 205, 206, the word-list window not displayed on the screen is again displayed in the screen by rolling up or down.

Preferably, the search server 3 of the present invention may search a search word and provide the search result contents searched by the search word to provide the related words in individual word-list windows 202 to 204 in every step. When the user selects a specific keyword as a search word in the second word-list window 203, the user terminal 2 transmits at least one keyword including the search word for search request, and receives the related words (a list of the related words) of the search word and the search results of a keyword combination including the search word. The list of the related words is displayed in the third word-list window 204, while the list of the search results is displayed in a search result window 207. Then, when the user selects a search word in the third word-list window 204, the user terminal 2 may transmit the search word of the third word-list window 204 or each search words selected in the second word-list window 203 and the third word-list window 204 for search request, receive the data of search result from the search server 3, and display, in the state of rolling up left by one column, the related words received from the search server 3 in the third word-list window 204 and the searched contents in the search result window 207.

As mentioned above, the provision of the related words and the search result by the search server 3 will be explained in detail as follows: In the case that the user terminal 2 shows a total of n number of word-list windows on the screen thereof, when the user selects a search word in a mth word-list window (where m is 1≦m≦n), the user terminal 2 transmits a search word selected in ‘m−1’th word-list window (‘m−1’th search word) by the user and the search word of a mth word-list window (mth search word) to the search server 3 for search request. The search server 3 provides a list of related words searched by the mth keyword and the contents of search results searched by the combination of the ‘m−1’th search word and the mth search word. The user terminal 2 displays the received related words in a ‘m+1’th word-list window, and in the case of m+1>n, the received related words are displayed in a nth window by rolling up to the left by one column. At the same time, the user terminal 2 displays the received search results in the search result window. Also, the search server 3 may send the search request including at least one search word to other search engines through an open API and provide search results received therefrom in the user terminal 2.

Moreover, the extended search which is performed step by step after the search server 3 receives the search word selected by the user will be explained in detail as follows: The extended search includes a first search performed for an input keyword in the search window by the user; a second search performed in combination of the input keyword and a first search word (the related word of the input keyword); and a third search performed in combination of the first search word and a second search word (the related word of the first search word). In this procedure, the user inputs the keyword and selects the first search word from the received related words of the user's input keyword, and selects the second search word from the received related words of the first search word, from which an extended search word is selected to perform the search procedure. As such a search procedure is repeated, a nth search may be extended.

Thus, in accordance with the present invention, after initially inputting a search word in the search window 201, an extended search word is selected in every step in which a list of related words is provided, thereby allowing the intended search. From this, the user is provided with a list of related words including unexpected related words and then checks the association thereof before selecting a search word to perform an extended search, from which the user can be provided with the intended search result step by step.

Meanwhile, FIG. 2 shows only three word-list windows 202 to 204 for convenience of explanation. However, the present invention is not limited thereto. In the present invention, n (n≧1) number of word-list windows may be arrayed on the screen. In the case of a mobile communication terminal or iphone having a small screen, one search window and one word-list window are arrayed to display a search word and a list of related words thereof. For example, among the related words, if a search word is selected, the selected search word is displayed in the search window, and related words of the selected search word are displayed in the word-list window. The previous search view may roll up or down by touching a left or right arrow button 205, 206.

In the above, although the search server 3 provides search results by using the combination of the two most recent search words selected by the user, the present invention is not limited to the number of search words. That is, if the user is allowed to select n number of search word after inputting a specific keyword, the user may finally select an optional number of search word from the keyword and the n number of search word and request the search thereof to the search server 3.

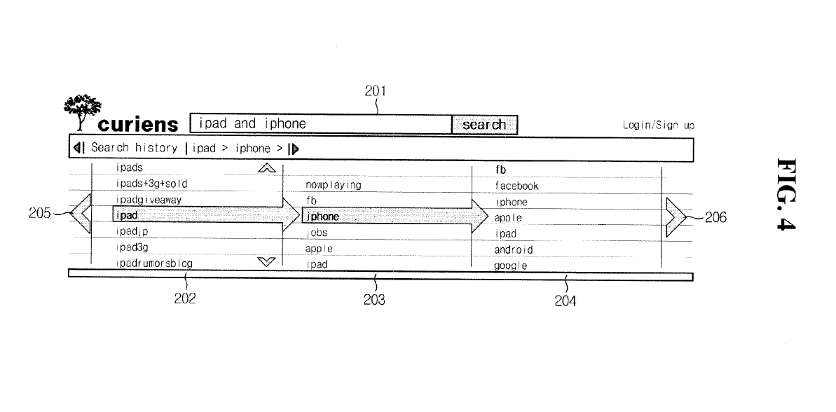

FIGS. 3 to 5 show captured search views according to one embodiment of the present invention.

Referring to FIG. 3, if the user inputs a search word “ipad” in the search window 202 and request the search thereof to the search server 3, the search results of similar words and related words are received, and the similar words are displayed in the first word-list window 202, and the related words, in the second word-list window 203.

As mentioned above, in the case of a small terminal having only one word-list window, the related words are displayed in one word-list window. Although not shown, a link of search result contents searched with “ipad” may be displayed on the bottom.

Referring to FIG. 4, if the user selects a search word “iphone” in the second word-list window 203 of FIG. 3 and request the search thereof to the search server 3, the search results of related words associated with “iphone” are received and displayed in the third word-list window 204. Although not shown, a contents link of search result searched by combining “ipad” and “iphone” may be displayed on the bottom.

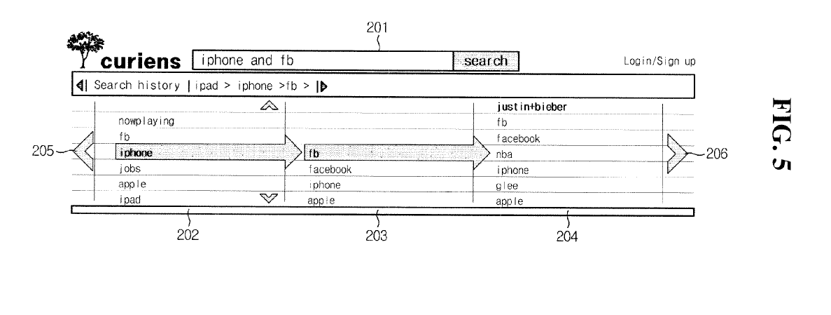

Referring to FIG. 5, if the user selects a search word “fb” in the third word-list window 204 of FIG. 4 and request the search thereof to the search server 3, the search results of related words associated with “fb” are received. At this time, since there are no remaining word-list windows on the screen, a shift to the left by one column is made. That is, the data of the second word-list window 203 of FIG. 4 are displayed in the first word-list window 202 of FIG. 5, the data of the third word-list window (204) of FIG. 4 are displayed in the second word-list window 203, and a list of the received related words of “fb” is displayed in the third word-list window 204 of FIG. 5. Similarly, although not shown, a contents link of search results searched by combining “iphone” and “fb” may be displayed on the bottom.

As mentioned with reference to FIGS. 3 to 5, the user inputs the search word “ipad”, and then selects “iphone” and “fb” step by step as an extended search word. Also, in each step, the search of contents is performed to accomplish a total of 3 times of extended searches, i.e., “ipad”, “ipad”+“iphone”, and “iphone”+“fb”. Thus, in accordance with the present invention, after inputting a keyword as a search word, the user is provided with the related words thereof, and selects a search word (an extended search word), thereby allowing an extended search as well as a detailed search.

Further, the user may again select the other search word instead of the previously selected search word in each step by going back to the previous step, and resume the search of the other selected search word.

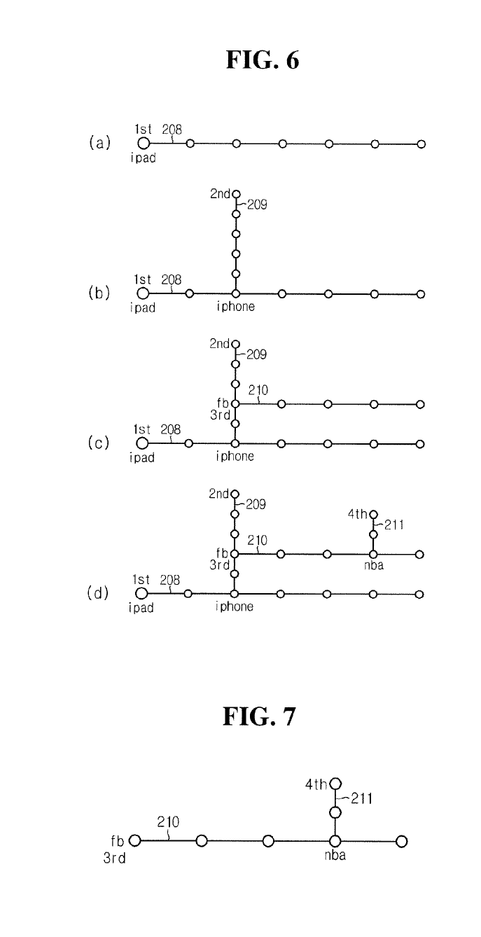

FIG. 6 illustrates an extended search word selection by using a graph according to one embodiment of the present invention.

Although FIGS. 2 to 5 show an extended search using a list of search words in a text form, the present invention comprises an extended search using a graph form. Referring to FIG. 6, in (a), if the user inputs a search word “ipad” in the search window 201 and requests the search thereof, the node information of related words is received from the search server 3, and the web browser of the user terminal 2 displays a first graph 208, in which related words are connected with each other by applying “ipad” as a first node, in a graph window of a relevant web site. Then, the user selects a specific node among the related words.

In (b), if the user selects “iphone” as a word node in the first graph 208, the search server 3 provides the node information of related words of the “iphone”, the user terminal 2 further displays a second graph 209 by adding in the first graph 208 in the graph window, the second graph 209 connecting the related words by applying “iphone” as a first node. Then, the user selects a specific node among the nodes of the second graph 209.

In (c), if the user selects “fb” as a word node in the second graph 209, the search server 3 provides the node information of related words of the “fb”, the user terminal 2 further displays a third graph 210 in adding the first graph 208 and second graph 209 in the graph window, the third graph 210 connecting the related words by applying “fb” as a first node. Then, the user selects a specific node among the nodes of the third graph 210.

In (d), if the user selects “nba” as a word node in the third graph 210, the search server 3 provides the node information of related words of the “nba”, the user terminal 2 further displays a fourth graph 211 in adding the first to third graphs 208 to in the graph window, the fourth graph 211 connecting the related words by applying “nba” as a first node. As this procedure is repeated, it is possible to be provided with an extended search word selection and content search results for the combination of search words.

FIG. 7 illustrates the display of a graph after initialization in the case that there is insufficient graph-displaying area in FIG. 6

Although the user is provided with the node information of related words of the “nba” after selecting “nba” as a word node in the third graph 210 in (c) of FIG. 6, the additional graph may be difficult to display due to insufficient space of the graph window.

In this case, as shown in FIG. 7, after initializing the graph window, the third graph 210 and the fourth graph 211 are newly displayed. Also, only the fourth graph 211 may be displayed. Meanwhile, in the case that the previous graph view is initialized out of the space and a new graph is displayed, the previous graph may be shown by rolling up the graph window by means of a button selection (or dragging). For example, a view on the screen is shifted from the graph of FIG. 7 to the graph (d) of FIG. 6.

Preferably, an interface of the extended search word selection using a graph form as shown in FIGS. 6 and 7 may be displayed together with an interface of the extended search word selection using a list of words as shown in FIGS. 2 to 5. For example, in FIGS. 3 to 5, whenever a user performs the search of a search word by using the search window 201 and the word-list windows 202 to 204, related words are received in a graph form and displayed in the graph window. At this time, the user can recognize the association of the search word with an extended search word by checking position and shape relations in a 3-dimensional method through the graph shown.

Also, the user may select the intended node among the total nodes present in graphs displayed on the screen before a search request.

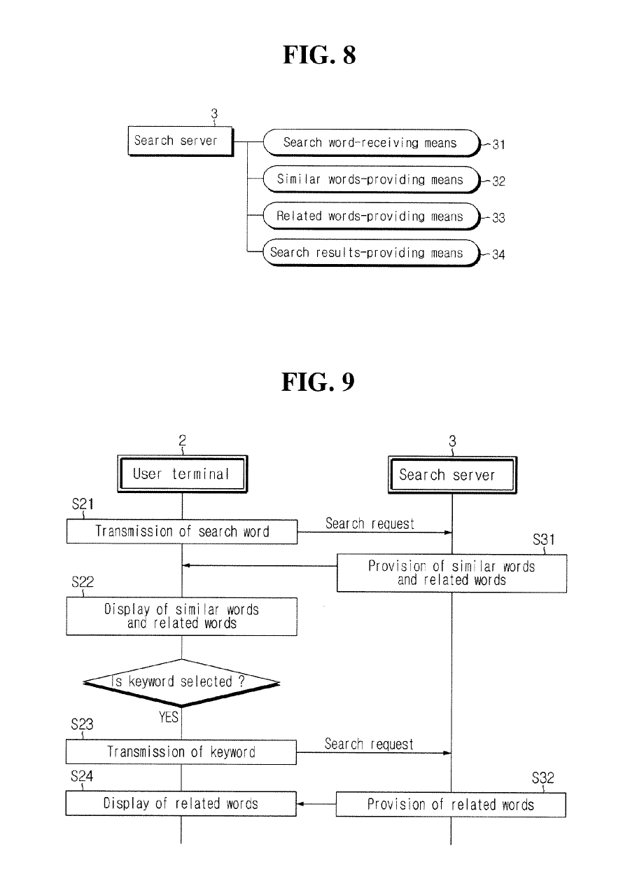

FIG. 8 schematically shows a configuration of the search server 3 according to one embodiment of the present invention.

The search server 3 according to one embodiment of the present invention comprises a search word-receiving means 31 for receiving a search word input by the user or a search word selected in a list of related words; a similar words-providing means 32 for searching the search word input by the user to provide similar words corresponding to the predictive words of the search word; a related words-providing means 33 for searching the received search word to provide related words having the association with the search word; and a search results-providing means 34 for searching at least one search word requested to find a relevant content and provide the search results thereof.

The extended search word selection system 1 will be explained for the function and operation of its components through the following extended search word selection method.

<2. Extended Search Word Selection Method>

The extended search word selection method according to one embodiment of the present invention is preferably implemented by using the foregoing extended search word selection system 1.

FIG. 9 shows a schematic flow chart of an extended search word selection method according to one embodiment of the present invention.

When a user terminal 2 accesses a website 300 of a search server 3, the search server 3 provides the user terminal 2 with the service of the extended search word selection.

First, a user inputs a search word in the search window 201 displayed in a web page provided from the search server 3 and touches a search button. The user terminal 2 transmits the search word to the search server 3 for search request (S21).

The search word-receiving means 31 of the search server 3 receives the search request, and the similar words-providing means 32 searches the search word to find similar words. The related words-providing means 33 searches for related words having association with the search word. The search of the related words may be performed by using a database including the field of association of words or a database including the field of keywords (tags) for each content. The search server 3 provides the search results of the similar words and a list of the related word searched by the search word (S31). Meanwhile, as mentioned above, such a search result may include the results of contents searched by the search results-providing means 34 with using the search word.

The user terminal 2 receives the search results, and displays the similar words in the first word-list window 202 and the related words in the second word-list window 203 (S22).

Next, when a search word is selected among the related words in the second word-list window 203, the user terminal 2 transmits the search request including the selected search word to the search server 3 (S23).

The search word-receiving means 31 receives the search request, the related words-providing means 33 searches the keyword to find its related words and provides the related words to the user terminal 2 (S32).

The user terminal 2 receives the search results of the related words and displays them in the word-list window 204 (S24). If there is no remaining word-list window as shown in FIG. 4, the word-list windows are rolled up to the left by one column to display the received related words as explained with reference to FIG. 5.

In the case that a search word is selected in a m (m≧1)th word-list window of the user terminal 2, as explained above, the user terminal 2 transmits the search request including a ‘m−1’th search word and a mth search word to the search server 3 and the search server 3 may provide the search results of the combination of such two search words to the user terminal 3.

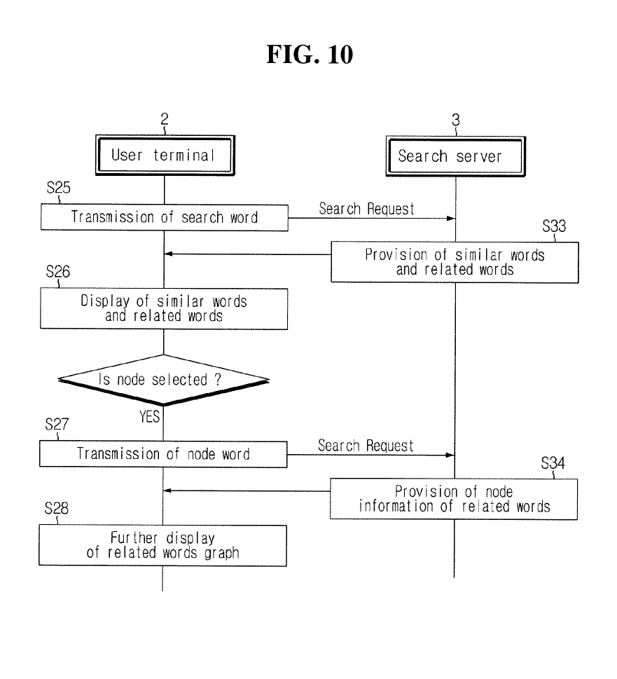

FIG. 10 shows a schematic flow chart of an extended search word selection method by using a graph according to one embodiment of the present invention.

In the present invention, an extended search word may be selected by the selection of a node by the user in a graph window displaying a graph form, not in a word-list window displaying a text form.

First, the user inputs a search word in the search window 201 displayed in a website view provided from the search server 3 and touches a search button. The user terminal 2 transmits the search word to the search server 3 for search request (S25).

The search word-receiving means 31 of the search server 3 receives the search request, and the similar words-providing means 32 searches the search word to find similar words. The related words-providing means 33 searches the search word to find related words having association with the search word. The finding of the related words may be performed by using a database including the association of words or a database including keywords (tags) for each content. The search server 3 produces node information for the graph display of the related word found using the search word and provides the node information to the user terminal 2 (S33). Meanwhile, as mentioned above, such a search result may comprise the results of contents found using the search word by the search results-providing means 34.

The user terminal 2 displays the node information of the related words in a graph window as explained in (a) of FIG. 6 (S26).

Next, when a specific word node is selected in the graph window, the user terminal 2 transmits the search request of the selected word to the search server 3 (S27).

The search word-receiving means 31 receives the search request, the related words-providing means 33 searches the keyword to find its related words and produce the node information thereof, and provides the node information to the user terminal 2 (S34).

The user terminal 2 receives the node information of the related words and further displays it on the graph window (S28). If there is insufficient space to display an additional graph, as shown in FIG. 7, the graph window is initialized and then a graph of the received related words is displayed.

Meanwhile, similar to FIG. 9, during performing a search using word-list windows based on a text, the search results of the received related words may also be displayed by using a graph window, as explained above.

Thus, the extended search word selection system and method according to the present invention has been described in detail with specific embodiments and drawings. However, it should be understood that the specific embodiments and drawings are given by way of illustration only, since various modifications and changes within the spirit and scope of the invention will become apparent to those skilled in the art from the detailed description.

What is claimed is:

1. An extended search word selection system, which whenever selecting a specific word in an individual word-list window displayed on a screen using a wire/wireless network, provides related words associated with the selected specific word in an adjacent word-list window, the system comprising a user terminal and a search server,
the search server being configured to receive a search word from the user terminal, search related words corresponding to the search word and provide the searched related words; and
the user terminal being configured to display at least one word-list window horizontally disposed on the screen; transmit a search word selected from the related words displayed in a first word-list window for search request; receive at least one related word from the search server to display the related words in a second word-list window adjacent to the first word-list window; and scroll the word-list windows left or right to display the word-list windows that are not displayed on the screen, thereby exhibiting the history of the selection of the search words and the related words of each search word on the screen.

2. The extended search word selection system according to claim 1, wherein when the user selects a specific search word in a mth word-list window where m is 1 or higher (m≧1), the user terminal displays the related words of the search word in a m+1’th word-list window, and in the case that the ‘m+1’th word-list window is not displayed on the screen, the user terminal scrolls the word-list window to the left to display the ‘m+1’th word-list on the screen.

3. The extended search word selection system according to claim 1 or 2, wherein the user terminal displays at least one search word selected by the user among the search word input by the user and the related words of total word-list windows, and transmits at least one word selected to the search server for search request.

4. The extended search word selection system according to claim 1 or 2, wherein the user terminal displays a search result-list window below the word-list windows on the screen; transmits a search word input by the user to the search server for search request;
receives similar words considered to be predictive words by adding a letter to the search word, the related words and the search results of the search word, and displays the search word and the similar words in the first word-list window while displaying the search results in the search result-list window,
wherein when the user selects a specific search word in a mth word-list window where m is 1 or higher (m≧1), the user terminal transmits a search word of a ‘m−1’th word-list window (‘m−1’th search word) and a search word of a mth word-list window (mth search word) to the search server for search request, receives related words of the mth search word and search results for the combination of the ‘m−1’th search word and the mth search word from the search server, and displays the received related words in a ‘m+1’th word-list window, while displaying the received search results in the search result-list window.

5. An extended search word selection system, which whenever selecting a specific word node in a graph using a wire/wireless network, provides the node information of related words of the specific word node in a graph displayed on a screen by connecting the nodes of the words with each other, the system comprising a user terminal and a search server,
the search server being configured to receive a word in the graph as a search word from the user terminal, search the word to find related words corresponding to the word, and provide the node information of the related words; and
the user terminal being configured to display a graph window on the screen;
transmit the word selected by the user as a search word to the search server when the specific word node is selected in the graph window, receives the node information of the related words from the search server, and displays the node information of the related words received by connecting the node information of the related words with the selected word node in the graph window in a graph form.

6. The extended search word selection system according to claim 1 or 5, wherein the search server has a database that stores core words and related words associated with the core words, and receives each search word selected by the user in every step and searches the search word as the core word to provide related words associated with the search word.

7. The extended search word selection system according to claim 1 or 5, wherein the related words are arrayed and displayed depending on the selection frequency of each word by the user and the number of contents corresponding to each related word.

8. The extended search word selection system according to claim 1, wherein the user terminal displays a graph window in which a plurality of words and related words of each word are connected in a node form and displayed in a graph form, on the screen; when selecting a specific search word in the individual word-list window, displays word nodes corresponding to the search word in the graph window, and when displaying the related words of the search word in the individual word-list window, further displays the node information of the related words of the search word in a graph form in the graph window by connecting the node information.

9. The extended search word selection system according to claim 1 or 8, in the state that a nth graph is displayed in the graph window, wherein the user terminal initializes the graph window to display a ‘n+1’th graph when the ‘n+1’th graph of the related words cannot be further displayed due to insufficient space on the graph-displaying area.

10. An extended search word selection method, which whenever a user selects a specific word in an individual word-list window displayed on a screen using a wire/wireless network, provides related words in an adjacent word-list window, the method comprising:
(a) inputting a search word in a search window displayed on the screen of a user terminal in which at least one word-list window are horizontally arrayed and displayed on the screen thereof, and transmitting the search word to a search server;
(b) searching the search word received in the search server to provide related words associated with the search word to the user terminal;
(c) displaying the related words received in a first word-list window of the user terminal;
(d) transmitting a specific related word selected as a search word to the search server when the specific related word is selected in the first word-list window;
(e) searching the search word received in the search server to provide its related words to the user terminal;
(f) displaying the related words received in a second word-list window adjacent to the first word-list window in the user terminal, and
(g) displaying the word-list windows not displayed on the screen by means of scrolling to the left or right in the user terminal to exhibit the history of the search words selected since the initial search and the related words of each search word on the screen.

11. The extended search word selection method according to claim 10, wherein when the user selects a specific search word in a mth word-list window where m is 1≦m≦n, related words of the search word are displayed in a ‘m+1’th word-list window, and in the case that the ‘m+1’th word-list window is not displayed on the screen, a list of words displayed on the screen is scrolled to the left to display the ‘m+1’th word-list window in the screen area.

12. The extended search word selection method according to claim 10 or 11, wherein the user terminal displays at least one search word selected by the user among the search word input by the user and the related words of total word-list windows, and transmits at least one word selected to the search server for search request.

13. The extended search word selection method according to claim 10 or 11, wherein the user terminal displays a search result-list window below the word-list windows on the screen; transmits a search word input by the user to the search server for search request; receives similar words considered to be predictive words by adding a letter to the search word, the related words and the search results of the search word, and displays the search word and the similar words in the first word-list window while displaying the search results in the search result-list window,
wherein when the user selects a specific search word in a mth word-list window where m is 1 or higher (m≧1), the user terminal transmits a search word of a ‘m−1’th word-list window (‘m−1’th search word) and a search word of a mth word-list window (mth search word) to the search server for search request, receives related words of the mth search word and search results for the combination of the ‘m−1’th search word and the mth search word from the search server, and displays the received related words in a ‘m+1’th word-list window, while displaying the received search results in the search result-list window.

14. An extended search word selection method, which whenever selecting a specific word node in a graph using a wire/wireless network, provides the node information of related words of the specific word node in a graph displayed on a screen by connecting the nodes of the words with each other, the method comprising:
(a1) inputting a search word in a search window displayed on the screen of a user terminal displaying a graph window, and transmitting the search word to a search server;
(b1) searching the search word received in the search server to find related words associated with the search word to the user terminal and providing the node information of the related words to the user terminal;
(c1) displaying the node information of the related words in a graph form by connecting it with the search word in the graph window of the user terminal;
(d1) transmitting a specific word node selected as a search word to the search server when the specific word node is selected in the first word-list window;
(e1) searching the search word received in the search server to find its related words to the user terminal and providing the node information of the related words to the user terminal; and
(f1) displaying the received node information of the related words in a graph form by connecting it with the selected word node in the graph window of the user terminal.

15. The extended search word selection method according to claim 10, wherein the user terminal displays a graph window in which a plurality of words and related words of each word are connected in a node form and displayed in a graph form, on the screen; when a specific search word is selected in the individual word-list window, displays word nodes corresponding to the search word in the graph window, and when related words of the search word are displayed in the individual word-list window, further displays the node information of the related words of the search word in a graph form in the graph window by connecting the node information.

16. The extended search word selection method according to claim 10 or 15, wherein in the state that a nth graph is displayed in the graph window, the user terminal initializes the graph window to display a ‘n+1’th graph when the ‘n+1’th graph of the related words cannot be further displayed due to insufficient graph-displaying area.
